(19) United States
(12) Patent Application Publication
(10) Pub. No.: US 2018/0224888 A1
(43) Pub. Date: Aug. 9, 2018

(54) WIRELESS CHARGING MOUSE WITH BATTERY

(71) Applicant: Intel Corporation, Santa Clara, CA (US)

(72) Inventor: MEENAKSHISUNDARAM GURUNATHAN, Bangalore (IN)

(73) Assignee: Intel Corporation, Santa Clara, CA (US)

(21) Appl. No.: 15/750,198

(22) PCT Filed: Jul. 22, 2016
(86) PCT No.: PCT/US2016/043715

§ 371 Date: Feb. 4, 2018

(30) Foreign Application Priority Data
Sep. 25, 2015 (IN) 5118/CHE/2015

(51) Int. Cl. G06F 1/16; G06F 3/0354; H02J 50/10; H02J 7/00; H02J 7/02

(52) U.S. Cl. CPC G06F 1/16; G06F 3/0354; H02J 7/025; H02J 7/0029; H02J 50/10

(57) ABSTRACT

Methods and apparatus relating to wireless charging through external peripheral device(s) are described. In an embodiment, a wireless charging receiver coil receives electromagnetic energy and a (e.g., wired) coupling transfers at least a portion of the received electromagnetic energy to a computing device. Other embodiments are also disclosed and claimed.

### RELATED APPLICATIONS

The present application claims priority under 35 U.S.C. 365(c) to IN Application No. 5118/CHE/2015 filed on Sep. 25, 2015. Said Application No. 5118/CHE/2015 is hereby incorporated herein by reference in its entirety.

### FIELD

The present disclosure generally relates to the field of electronics. More particularly, an embodiment relates to techniques for wireless charging mouse with battery.

### BACKGROUND

Inductive wireless charging pads are emerging as a promising technology to replace traditional wired chargers for portable computing devices. However, implementation of wireless charging in all types of devices may not be practical, beneficial, or cost-effective. For example, due to form factor goals and/or weight considerations, integration of wireless charging technology in some laptop computers may not be feasible. Also, integration of wireless charging technology in legacy systems may be aesthetically unpleasing, difficult, or cost-prohibitive.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 shows a block diagram of a wireless charging system, according to an embodiment.

FIG. 2 illustrates a bottom view of a mouse with wireless charging capability, according to an embodiment.

FIG. 3 illustrates a cross-sectional view of a mouse with wireless charging capability, according to an embodiment.

FIG. 4 illustrates information about battery characteristics, according to some embodiments.

FIGS. 5, 6, 7, and 8 illustrate block diagrams of embodiments of computing systems, which may be utilized to implement various embodiments discussed herein.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, inductive wireless charging pads are emerging as a promising technology to replace traditional wired chargers for portable computing devices. However, implementation of wireless charging in all types of devices may not be practical, beneficial, or cost-effective. For example, due to form factor goals and/or weight considerations, integration of wireless charging technology in some laptop computers may not be feasible. Also, integration of wireless charging technology in legacy systems may be aesthetically unpleasing, difficult, or cost-prohibitive.

Moreover, even though wireless charging is becoming popular for portable computers like Ultrabook™ computing devices and laptops, many Original Equipment Manufacturers (OEMs) still do not support wireless charging. This limits these laptops to being charged only through conventional wall chargers. Further, most new laptops have USB (Universal Serial Bus) type C ports which could be used for charging the laptop.

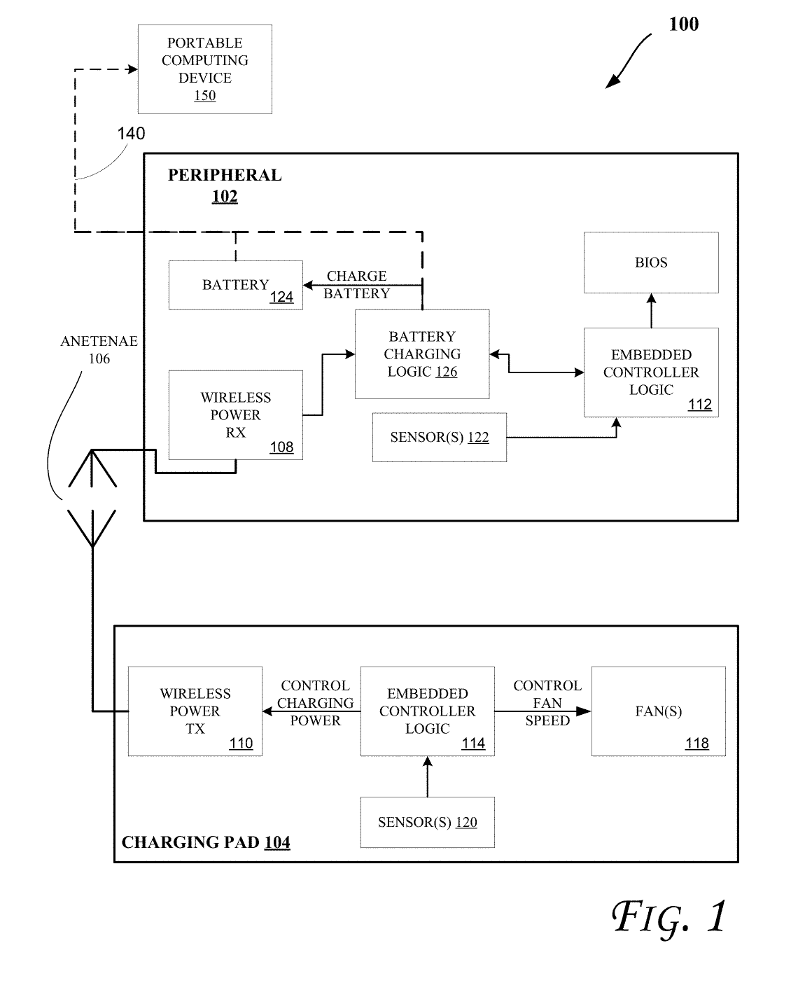

To this end, some embodiments provide techniques for wireless charging of a portable computing device by utilizing a peripheral device with a wire capable of providing charging or operating voltage and/or current (e.g., a USB type-C compatible wire). Also, usage of such embodiments is not limited to portable computing devices, and the charging or operating voltage/current may be provided to a non-portable computing device. Moreover, the peripheral device may include wireless charging logic and one or more battery packs (such as discussed with reference to FIG. 1). In turn, the wireless charging facilities of the peripheral device are used to charge (or provide operating current/voltage to) a computing device coupled to the peripheral device via a wire. Furthermore, while some embodiments are discussed herein with reference to a mouse, any type of peripheral device with wireless charging technology may be used to assist in charging a computing device. Also, the wire used is not limited to a USB type-C wire and any type of wire coupled between a computing device and a peripheral computing device (with wireless charging logic) that is capable of providing a charge or operating current and/or voltage to the computing device may be utilized.

Additionally, the portable computing devices discussed herein (that are being charged through the wireless charging capabilities of a peripheral device) may include any type of a portable computing device, such as a 2:1 system, smartphone, tablet, UMPC (Ultra-Mobile Personal Computer), laptop computer, Ultrabook™ computing device, wearable devices (such as smart watch, smart glasses, smart bracelets, and the like (such as those discussed with reference to FIGS. 1-8).

As discussed herein, a “2:1” computing device generally refers to a portable (also referred to herein interchangeably as “mobile” or “portable”) computing device that includes a tablet portion (which may include one or more of: a System On Chip (SOC), a flat panel display device (such as an Liquid Crystal Display (LCD)), battery pack(s), charging antenna(s), etc.) and a base or keyboard portion (that may include one or more of: an SOC, one or more battery pack(s), storage device(s), charging antenna(s), etc.). In some implementations, the base or keyboard portion may provide a mechanism for inputting data (such as one or more of: a keyboard, a mouse, a touchpad, etc.). Also, a 2:1 mobile computing device may include two modes of use or configurations: first, a tablet mode, where the tablet portion is used as a table computing device; and second, a slate mode, where the tablet portion and the base/keyboard portions are coupled.

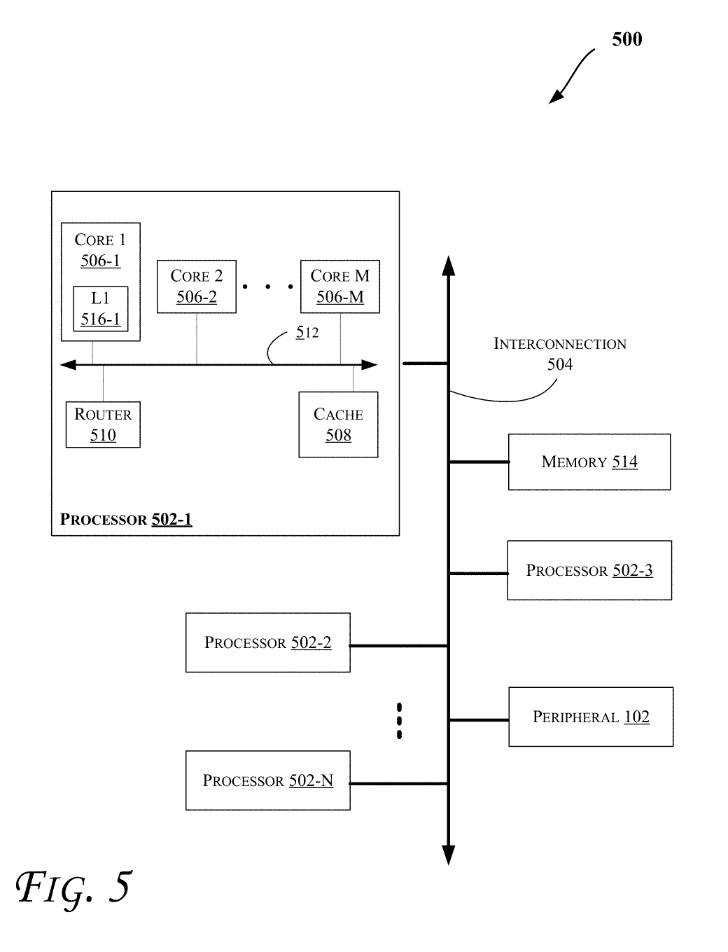

FIG. 1 shows a block diagram of a computing system 100 with wireless charging capability, according to an embodiment. System 100 includes a peripheral device 102 and a charging pad 104. Antennae 106 (e.g., at least one for each device 102 and pad 104) enable wireless transmission of electromagnetic energy/waves from the charging pad 104 to the device 102 to allow for wireless charging. In an embodiment, peripheral device 102 is coupled to a mobile or portable computing device(s) 150 via a wire 140. The portable computing device 150 may include a 2:1 system, smartphone, tablet, UMPC (Ultra-Mobile Personal Computer), laptop computer, Ultrabook™ computing device, wearable devices (such as smart watch, smart glasses, smart bracelets, and the like (such as those discussed with reference to FIGS. 5-8). The battery 124 of the peripheral 102 (and/or the wireless power received via wireless power receiver 108 (not shown) or from battery charging logic 126) may then be used via the wire 140 to charge the portable computing device 150.

As shown, peripheral device 102 includes a wireless power receiver (RX) 108 to receive electromagnetic waves (through one of antennae 106 directly coupled to the RX 108) and charging pad 104 includes a wireless power transmitter (TX) 110 to transmit the electromagnetic waves (through one of antennae 106 directly coupled to TX).

Referring to FIG. 1, when device 102 is first placed on the pad 104, an Embedded Controller (EC) or logic 112 detects the presence of the charging pad by communicating with pad EC or logic 114 and optionally negotiating a protocol for transfer of system information to the charging pad. In an embodiment, EC 114 is responsible for detecting and communicating dock/undock events, for example, when the peripheral 102 is placed on the pad for wireless charging or removed from the pad. EC 114 coordinates with EC 112 to detect system presence and negotiates peripheral communication protocol using available interconnects, such as those discussed with reference to FIGS. 5-8 (including for example Universal Serial Bus(USB), Interface to Communicate (I2C), Bluetooth (BT), Near Field Communication (NFC), etc.).

In an embodiment, EC 114 is responsible for making three decisions: (1) adjust the wireless power levels for transmitter 110; (2) control the speed of one or more fans 118 (coupled or provided in the charging pad); and (3) react to thermal issues (e.g., as detected based on input from one or more sensors 120) by increasing/decreasing speed of fans 118. Also, as the current or voltage level of one or more battery packs 124 and/or detected temperature at a component of the device 102 increases (e.g., as determined/detected by battery charging logic 126 and/or sensor(s) 122), EC 112 (or logic 126) may cause lowering of charging levels provided by the logic 126.

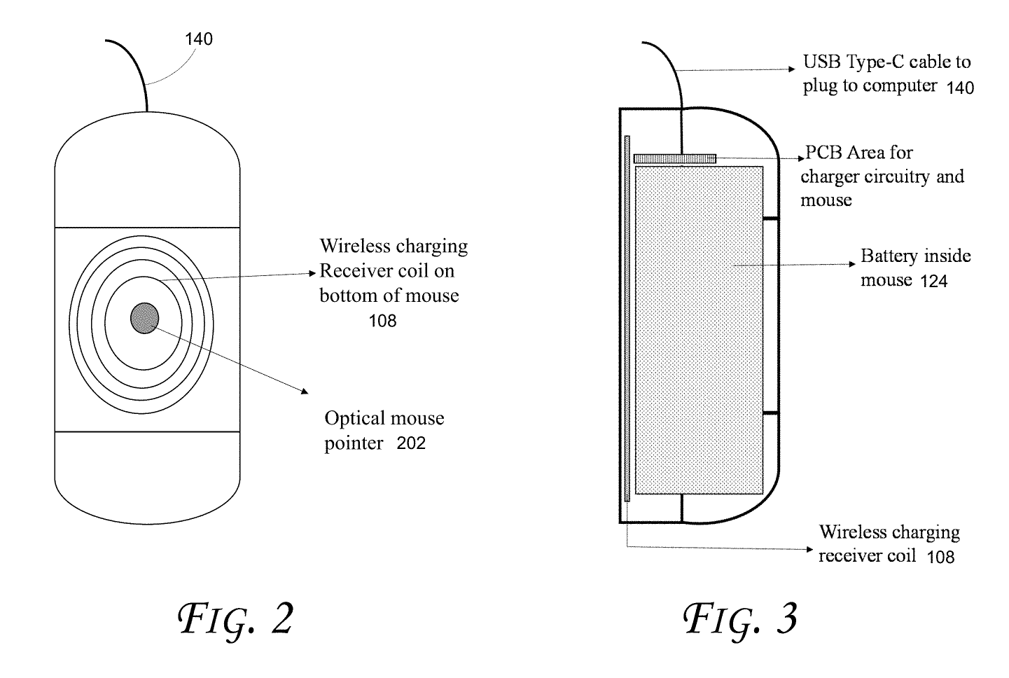

FIG. 2 illustrates a bottom view of a mouse with wireless charging, according to an embodiment. As previously discussed, peripheral 102 of FIG. 1 may be any type of a peripheral device (external or internal) to the portable computing device 150. In various embodiments, the peripheral device can be a mouse, a trackpad, a keyboard, a smartphone, a touchpad, a power bank (or external battery pack, capable of providing charging or operating power to the portable computing device 150), or any other peripheral device having one or more components discussed with reference to the peripheral 102 of FIG. 1.

Referring to FIG. 2, a sample peripheral device 102 (i.e., an external mouse) is shown. The external mouse includes a wireless charging receiver along with a type C compatible USB jack (e.g., wire 140). This mouse can be placed on a wireless charging mat (e.g., charging pad 104), which may also act as a mouse pad. Hence, when the mouse is coupled to the portable computing device 150, the portable computing device can be powered (and/or its battery pack(s) charged) by the external mouse through the wire 140.

In an embodiment, the mouse of FIG. 2 can act as an external power-bank by having an internal battery 124 in the mouse. In some embodiments, the battery 124 is charged whenever the mouse is not coupled via wire 140 to the portable computing device 150 or if the mouse is coupled to the portable computing device 150 and the portable computing device's battery is fully charged. Such embodiments can provide a low cost wireless charging solution that can even be used for portable computing device′ which do not have an internal wireless charging coil.

FIG. 3 illustrates a side cross-sectional view of the mouse of FIG. 2, according to an embodiment. An embodiment proposes to use the external mouse to charge the portable computing device 150. The illustrated mouse includes the wireless charging receiver coil 108 on the bottom side as shown in FIG. 2. The mouse may include a battery 124 as shown in cross-section view in FIG. 3. It is envisioned that most peripheral devices (such as a mouse) may include an area/space not fully utilized for components, in part, since peripheral devices are designed with ergonomic features in mind (such as a mouse that comfortably fits into a user's palm). To this, in an embodiment, the battery 124 may be provided in an area of the mouse that is not otherwise used. This battery can be charged when the mouse is kept on top of a wireless charging pad 104 (which may also act as a mouse pad). The mouse has a wire 104 (e.g., a type C compatible USB wire). In an embodiment, when the external mouse is plugged into a (e.g., USB type C) port of the computing device 150, it will start charging the computing device. As shown in FIG. 3, the mouse may include a PCB (Printed Circuit Board) area for the circuitry discussed with reference to the peripheral device 102 of FIG. 1.

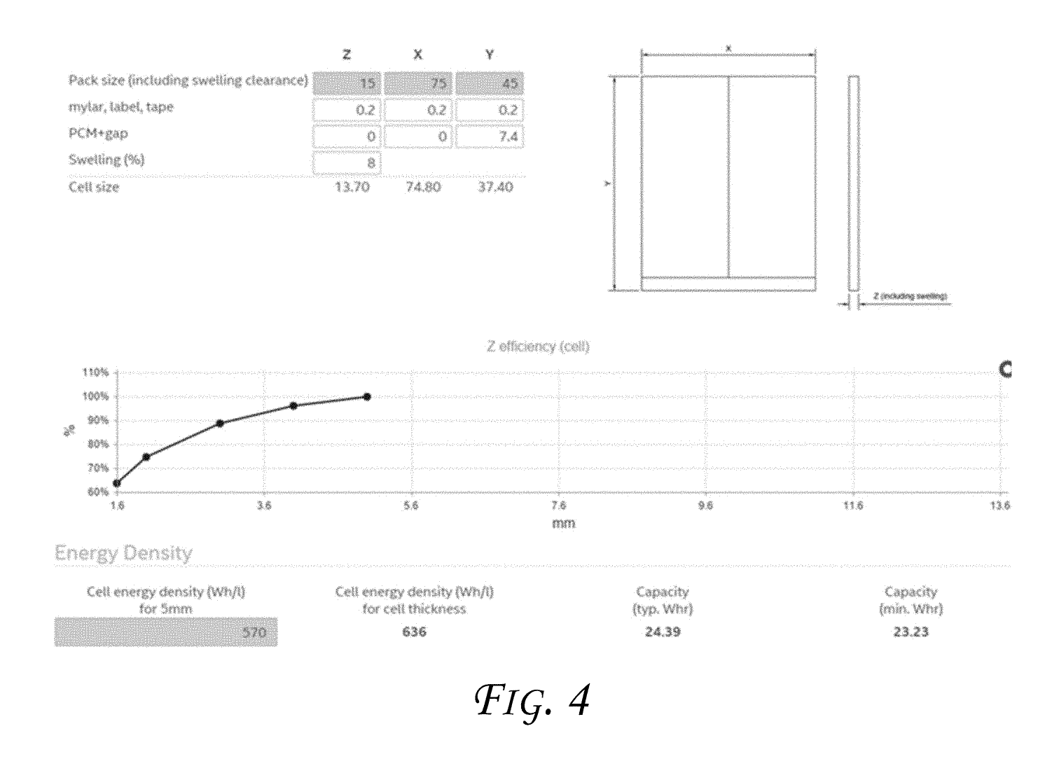

FIG. 4 illustrates information about battery size, capacity, efficiency, and performance, according to some embodiments. As shown in FIG. 4, it is estimated that a battery size of “75 mm×45 mm×15 mm” can be accommodated into the mouse of FIGS. 2 and/or 3. For this area, we can expect a typical battery capacity of about 25 WHr (Watt Hour) as shown in the estimation of FIG. 4. This battery capacity is as good as the batteries used in popular tablets and Ultrabook computing devices.

Some embodiments may be applied in computing systems that include one or more processors (e.g., with one or more processor cores), such as those discussed with reference to FIGS. 5-8, including for example mobile computing devices such as a 2:1 system, smartphone, tablet, UMPC (Ultra-Mobile Personal Computer), laptop computer, Ultrabook™ computing device, wearable devices (such as smart watch, smart glasses, smart bracelets, and the like), etc. More particularly, FIG. 5 illustrates a block diagram of a computing system 500, according to an embodiment. The system 500 may include one or more processors 502-1 through 502-N (generally referred to herein as “processors 502” or “processor 502”).

The processors 502 may be general-purpose CPUs (Central Processing Units) and/or GPUs (Graphics Processing Units) in various embodiments. The processors 502 may communicate via an interconnection or bus 504. Each processor may include various components some of which are only discussed with reference to processor 502-1 for clarity. Accordingly, each of the remaining processors 502-2 through 502-N may include the same or similar components discussed with reference to the processor 502-1.

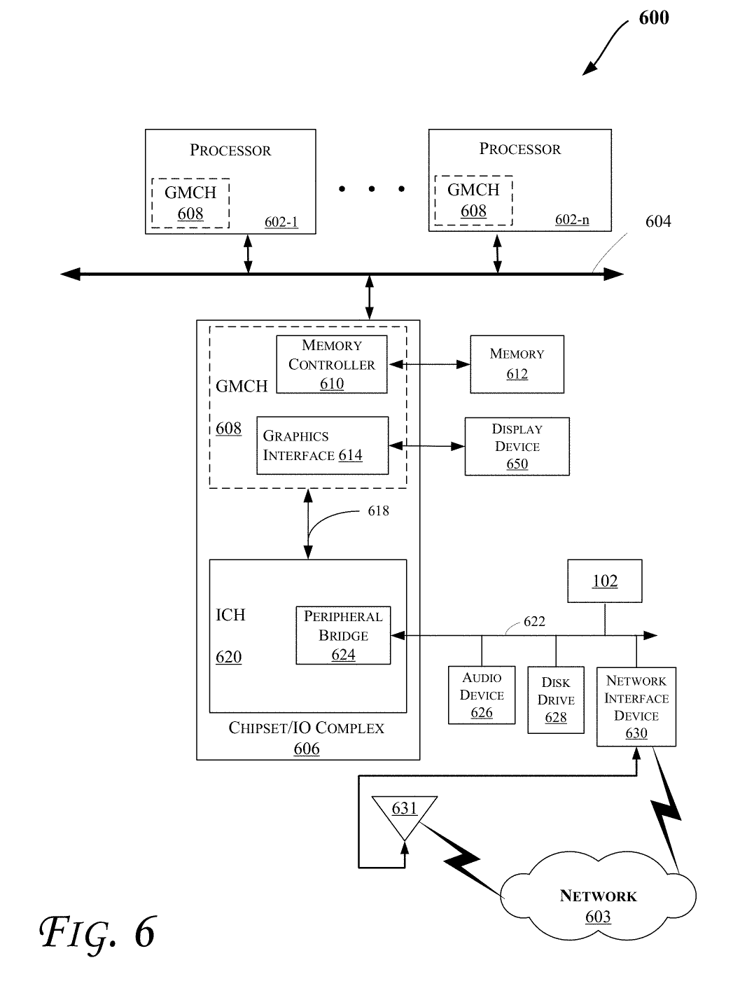

In an embodiment, the processor 502-1 may include one or more processor cores 506-1 through 506-M (referred to herein as “cores 506,” or “core 506”), a cache 508, and/or a router 510. The processor cores 506 may be implemented on a single integrated circuit (IC) chip. Moreover, the chip may include one or more shared and/or private caches (such as cache 508), buses or interconnections (such as a bus or interconnection 512), graphics and/or memory controllers (such as those discussed with reference to FIGS. 6-8), or other components.

In one embodiment, the router 510 may be used to communicate between various components of the processor 502-1 and/or system 500. Moreover, the processor 502-1 may include more than one router 510. Furthermore, the multitude of routers 510 may be in communication to enable data routing between various components inside or outside of the processor 502-1.

The cache 508 may store data (e.g., including instructions) that are utilized by one or more components of the processor 502-1, such as the cores 506. For example, the cache 508 may locally cache data stored in a memory 514 for faster access by the components of the processor 502 (e.g., faster access by cores 506). As shown in FIG. 5, the memory 514 may communicate with the processors 502 via the interconnection 504. In an embodiment, the cache 508 (that may be shared) may be a mid-level cache (MLC), a last level cache (LLC), etc. Also, each of the cores 506 may include a Level 1 (L1) cache (516-1) (generally referred to herein as “L1 cache 516”) or other levels of cache such as a Level 2 (L2) cache. Moreover, various components of the processor 502-1 may communicate with the cache 508 directly, through a bus (e.g., the bus 512), and/or a memory controller or hub.

As shown, system 500 may be coupled to the peripheral 102 as discussed herein. For example, sensor(s) 122 may be provided proximate to components of system 500, including, for example, the cores 506, interconnections 504 or 512, components outside of the processor 502 (like a voltage regulator and/or power source (not shown)), etc., to sense variations in various factors effecting power/thermal behavior of the system/platform, such as temperature, operating frequency, operating voltage, power consumption, and/or inter-core communication activity, etc. In an embodiment, at least one sensor 122 may be coupled to a dock (e.g., charging pad 104) to detect when the peripheral device 102 is docked or otherwise attached to the dock. System 500 also includes logic 112 to control thermal behavior and/or charging performance of components of system 500, e.g., based on information received from the sensor(s) 120 and/or 122 as discussed herein.

FIG. 6 illustrates a block diagram of a computing system 600 in accordance with an embodiment. The computing system 600 may include one or more Central Processing Units (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)).

Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 502 of FIG. 5. Further, one or more components of system 600 may be coupled to the peripheral device 102, as discussed with reference to FIGS. 1-5 (including but not limited to those locations illustrated in FIG. 6). Also, the operations discussed with reference to FIGS. 1-5 may be performed by one or more components of the system 600.

A chipset 606 may also communicate with the interconnection network 604. The chipset 606 may include a graphics memory control hub (GMCH) 608, which may be located in various components of system 600 (such as those shown in FIG. 6). The GMCH 608 may include a memory controller 610 that communicates with a memory 612 (which may be the same or similar to the memory 514 of FIG. 5). The memory 612 may store data, including sequences of instructions, that may be executed by the CPU 602, or any other device included in the computing system 600. In one embodiment, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The GMCH 608 may also include a graphics interface 614 that communicates with the display device. In one embodiment, the graphics interface 614 may communicate with a display device via an accelerated graphics port (AGP) or Peripheral Component Interconnect (PCI) (or PCI express (PCIe) interface). In an embodiment, the display (such as a flat panel display) may communicate with the graphics interface 614 through, for example, a signal converter that translates a digital representation of an image stored in a storage device such as video memory or system memory into display signals that are interpreted and displayed by the display device. The display signals produced by the display device may pass through various control devices before being interpreted by and subsequently displayed on the display device.

A hub interface 618 may allow the GMCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. As shown, the network interface device 630 may be coupled to an antenna 631 to wirelessly (e.g., via an Institute of Electrical and Electronics Engineers (IEEE) 802.11 interface (including IEEE 802.11a/b/g/n/ac, etc.), cellular interface, 3G, 5G, LPE, etc.) communicate with the network 603. Other devices may communicate via the bus 622. Also, various components (such as the network interface device 630) may communicate with the GMCH 608. In addition, the processor 602 and the GMCH 608 may be combined to form a single chip. Furthermore, a graphics accelerator may be included within the GMCH 608 in other embodiments. Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

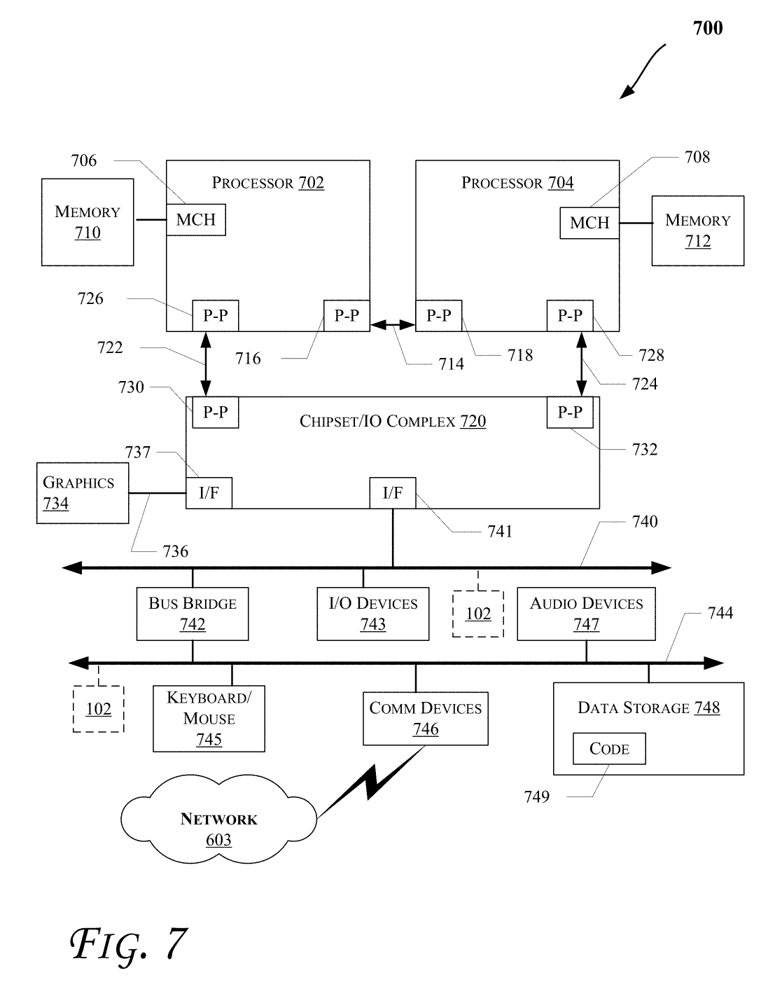

FIG. 7 illustrates a computing system 700 that is arranged in a point-to-point (PtP) configuration, according to an embodiment. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a graphics circuit 734 via a graphics interface 736, e.g., using a PtP interface circuit 737.

At least one embodiment may be provided within the processors 702 and 704. Further, one or more components of system 700 may be coupled to the peripheral device 102, discussed with reference to FIGS. 1-6 (including but not limited to those locations illustrated in FIG. 7). Other embodiments, however, may exist in other circuits, logic units, or devices within the system 700 of FIG. 7. Furthermore, other embodiments may be distributed throughout several circuits, logic units, or devices illustrated in FIG. 7.

The chipset 720 may communicate with a bus 740 using a PtP interface circuit 741. The bus 740 may communicate with one or more devices, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device 747, and/or a data storage device 748. The data storage device 748 may store code 749 that may be executed by the processors 702 and/or 704.

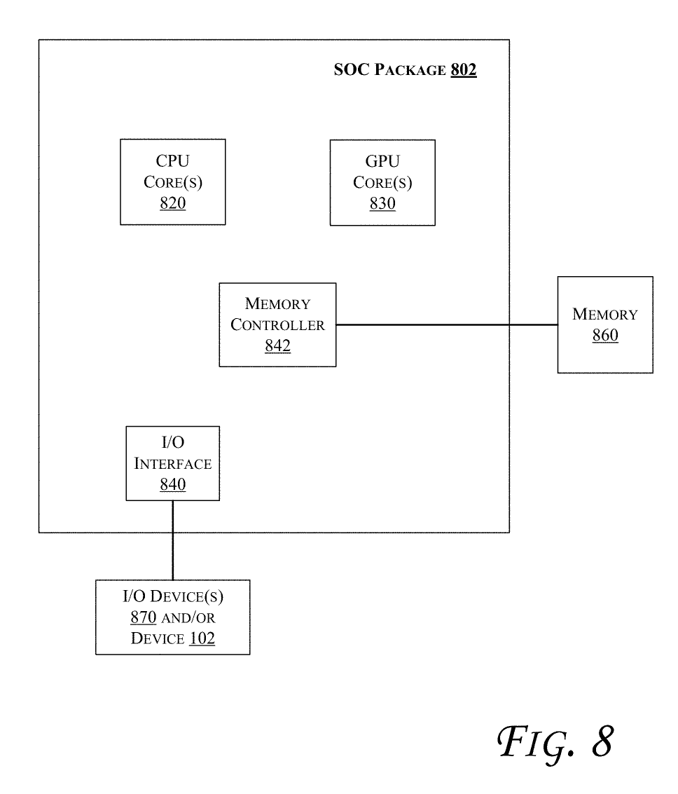

In some embodiments, one or more of the components discussed herein can be embodied as a System On Chip (SOC) device. FIG. 8 illustrates a block diagram of an SOC package in accordance with an embodiment. As illustrated in FIG. 8, SOC 802 includes one or more Central Processing Unit (CPU) cores 820, one or more Graphics Processing Unit (GPU) cores 830, an Input/Output (I/O) interface 840, and a memory controller 842. Various components of the SOC package 802 may be coupled to an interconnect or bus such as discussed herein with reference to the other figures. Also, the SOC package 802 may include more or less components, such as those discussed herein with reference to the other figures. Further, each component of the SOC package 820 may include one or more other components, e.g., as discussed with reference to the other figures herein. In one embodiment, SOC package 802 (and its components) is provided on one or more Integrated Circuit (IC) die, e.g., which are packaged into a single semiconductor device.

As illustrated in FIG. 8, SOC package 802 is coupled to a memory 860 (which may be similar to or the same as memory discussed herein with reference to the other figures) via the memory controller 842. In an embodiment, the memory 860 (or a portion of it) can be integrated on the SOC package 802.

The I/O interface 840 may be coupled to one or more I/O devices 870 (e.g., including peripheral device 102), e.g., via an interconnect and/or bus such as discussed herein with reference to other figures. I/O device(s) 870 may include one or more of a keyboard, a mouse, a touchpad, a display device, an image/video capture device (such as a camera or camcorder/video recorder), a touch screen, a speaker, or the like.

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 6 and/or 7, including for example a flat panel display device, etc.).

The following examples pertain to further embodiments. Example 1 includes an apparatus comprising: a wireless charging receiver coil to receive electromagnetic energy; and a coupling to transfer at least a portion of the received electromagnetic energy to a computing device. Example 2 includes the apparatus of example 1, further comprising one or more battery packs to store at least a portion of the received electromagnetic energy. Example 3 includes the apparatus of example 1, further comprising one or more battery packs to store at least a portion of the received electromagnetic energy, wherein the coupling is to transfer at least a portion of the stored electromagnetic energy to the computing device. Example 4 includes the apparatus of example 1, wherein the coupling is to comprise a Universal Serial Bus (USB) coupling. Example 5 includes the apparatus of example 4, wherein the USB coupling includes a type C USB coupling. Example 6 includes the apparatus of example 1, wherein the apparatus is to comprise a peripheral device. Example 7 includes the apparatus of example 6, wherein the peripheral device is to comprise one of: a mouse, a trackpad, a keyboard, a smartphone, a touchpad, and a power bank. Example 8 includes the apparatus of example 1, wherein a wireless charging pad is to transmit the electromagnetic energy to the wireless charging receiver coil. Example 9 includes the apparatus of example 8, comprising logic to cause modification to speed of one or more fans, coupled to the wireless charging pad, based at least in part on one or more of: a docking status of the apparatus, one or more detected temperature values, a battery charge level, and one or more wireless charging pad temperature values to be detected by one or more wireless charging pad sensors that are to be proximate to one or more components of the wireless charging pad. Example 10 includes the apparatus of example 1, further comprising one or more antennae to receive electromagnetic waves from a wireless charging transmitter. Example 11 includes the apparatus of example 1, wherein the computing device is to comprise a portable computing device. Example 12 includes the apparatus of example 11, wherein the portable computing device is to comprise one or more of: a System On Chip (SOC) device; a processor, having one or more processor cores; a flat panel display device, and memory. Example 13 includes the apparatus of example 11, wherein the apparatus is to provide a communication interface for the portable computing device using one or more of: a wireless interface, a Bluetooth (BT) interface, or a Near Field Communication (NFC) interface. Example 14 includes the apparatus of example 11, wherein the portable computing device is to comprise one of: a smartphone, a 2:1 system, a tablet, a phablet, a UMPC (Ultra-Mobile Personal Computer), a laptop computer, an Ultrabook™ computing device, and a wearable device.

Example 15 includes an apparatus comprising: a wired coupling to transfer at least a portion electromagnetic energy to be received at a wireless charging receiver coil of a peripheral device. Example 16 includes the apparatus of example 15, further comprising one or more battery packs to store at least a portion of the transferred electromagnetic energy. Example 17 includes the apparatus of example 15, wherein the peripheral device is to comprise one or more battery packs to store at least a portion of the received electromagnetic energy, wherein the wired coupling is to transfer at least a portion of the stored electromagnetic energy to the apparatus. Example 18 includes the apparatus of example 15, wherein the wired coupling is to comprise a Universal Serial Bus (USB) coupling. Example 19 includes the apparatus of example 18, wherein the USB coupling includes a type C USB coupling. Example 20 includes the apparatus of example 15, wherein the peripheral device is to comprise one of: a mouse, a trackpad, a keyboard, a smartphone, a touchpad, and a power bank. Example 21 includes the apparatus of example 15, wherein a wireless charging pad is to transmit the electromagnetic energy to the wireless charging receiver coil. Example 22 includes the apparatus of example 21, comprising logic to cause modification to speed of one or more fans, coupled to the wireless charging pad, based at least in part on one or more of: a docking status of the peripheral device, one or more detected temperature values, a battery charge level, and one or more wireless charging pad temperature values to be detected by one or more wireless charging pad sensors that are to be proximate to one or more components of the wireless charging pad. Example 23 includes the apparatus of example 15, wherein the peripheral device is to comprise one or more antennae to receive electromagnetic waves from a wireless charging transmitter. Example 24 includes the apparatus of example 15, wherein the apparatus is to comprise a portable computing device. Example 25 includes the apparatus of example 24, wherein the portable computing device is to comprise one or more of: a System On Chip (SOC) device; a processor, having one or more processor cores; a flat panel display device, memory, a sensor, a wireless communication interface, a Bluetooth interface, and an NFC (Near Field communication) interface. Example 26 includes the apparatus of example 24, wherein the portable computing device is to comprise one of: a smartphone, a 2:1 system, a tablet, a phablet, a UMPC (Ultra-Mobile Personal Computer), a laptop computer, an Ultrabook™ computing device, and a wearable device.

Example 27 includes a computing system comprising: a computing device; and a peripheral device coupled to the computing device via a coupling, wherein the peripheral device is to comprise a wireless charging receiver coil to receive electromagnetic energy, wherein the coupling is to transfer at least a portion of the received electromagnetic energy to the computing device. Example 28 includes the system of example 27, further comprising one or more battery packs to store at least a portion of the received electromagnetic energy. Example 29 includes the system of example 27, further comprising one or more battery packs to store at least a portion of the received electromagnetic energy, wherein the coupling is to transfer at least a portion of the stored electromagnetic energy to the computing device. Example 30 includes the system of example 27, wherein the coupling is to comprise a Universal Serial Bus (USB) coupling. Example 31 includes the system of example 30, wherein the USB coupling includes a type C USB coupling. Example 32 includes the system of example 27, wherein the apparatus is to comprise a peripheral device. Example 33 includes the system of example 32, wherein the peripheral device is to comprise one of: a mouse, a trackpad, a keyboard, a smartphone, a touchpad, and a power bank. Example 34 includes the system of example 27, wherein a wireless charging pad is to transmit the electromagnetic energy to the wireless charging receiver coil. Example 35 includes the system of example 34, comprising logic to cause modification to speed of one or more fans, coupled to the wireless charging pad, based at least in part on one or more of: a docking status of the apparatus, one or more detected temperature values, a battery charge level, and one or more wireless charging pad temperature values to be detected by one or more wireless charging pad sensors that are to be proximate to one or more components of the wireless charging pad. Example 36 includes the system of example 27, further comprising one or more antennae to receive electromagnetic waves from a wireless charging transmitter. Example 37 includes the system of example 27, wherein the computing device is to comprise a portable computing device. Example 38 includes the system of example 37, wherein the portable computing device is to comprise one or more of: a System On Chip (SOC) device; a processor, having one or more processor cores; a flat panel display device, and memory. Example 39 includes the system of example 37, wherein the apparatus is to provide a communication interface for the portable computing device using one or more of: a wireless interface, a Bluetooth (BT) interface, or a Near Field Communication (NFC) interface. Example 40 includes the system of example 37, wherein the portable computing device is to comprise one of: a smartphone, a 2:1 system, a tablet, a phablet, a UMPC (Ultra-Mobile Personal Computer), a laptop computer, an Ultrabook™ computing device, and a wearable device.

Example 41 includes an apparatus comprising means to perform a method as set forth in any preceding example. Example 42 comprises machine-readable storage including machine-readable instructions, when executed, to implement a method or realize an apparatus as set forth in any preceding example.

In various embodiments, the operations discussed herein, e.g., with reference to FIGS. 1-8, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-8.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-25. (canceled)

26. An apparatus comprising:
a wireless charging receiver coil to receive electromagnetic energy; and
a coupling to transfer at least a portion of the received electromagnetic energy to a computing device.

27. The apparatus of claim 26, further comprising one or more battery packs to store at least a portion of the received electromagnetic energy.

28. The apparatus of claim 26, further comprising one or more battery packs to store at least a portion of the received electromagnetic energy, wherein the coupling is to transfer at least a portion of the stored electromagnetic energy to the computing device.

29. The apparatus of claim 26, wherein the coupling is to comprise a Universal Serial Bus (USB) coupling.

30. The apparatus of claim 29, wherein the USB coupling includes a type C USB coupling.

31. The apparatus of claim 26, wherein the apparatus is to comprise a peripheral device.

32. The apparatus of claim 31, wherein the peripheral device is to comprise one of: a mouse, a trackpad, a keyboard, a smartphone, a touchpad, and a power bank.

33. The apparatus of claim 26, wherein a wireless charging pad is to transmit the electromagnetic energy to the wireless charging receiver coil.

34. The apparatus of claim 33, comprising logic to cause modification to speed of one or more fans, coupled to the wireless charging pad, based at least in part on one or more of: a docking status of the apparatus, one or more detected temperature values, a battery charge level, and one or more wireless charging pad temperature values to be detected by one or more wireless charging pad sensors that are to be proximate to one or more components of the wireless charging pad.

35. The apparatus of claim 26, further comprising one or more antennae to receive electromagnetic waves from a wireless charging transmitter.

36. The apparatus of claim 26, wherein the computing device is to comprise a portable computing device.

37. The apparatus of claim 36, wherein the portable computing device is to comprise one or more of: a System On Chip (SOC) device; a processor, having one or more processor cores; a flat panel display device, and memory.

38. The apparatus of claim 36, wherein the apparatus is to provide a communication interface for the portable computing device using one or more of: a wireless interface, a Bluetooth (BT) interface, or a Near Field Communication (NFC) interface.

39. An apparatus comprising:
a wired coupling to transfer at least a portion electromagnetic energy to be received at a wireless charging receiver coil of a peripheral device.

40. The apparatus of claim 39, further comprising one or more battery packs to store at least a portion of the transferred electromagnetic energy.

41. The apparatus of claim 39, wherein the peripheral device is to comprise one or more battery packs to store at least a portion of the received electromagnetic energy, wherein the wired coupling is to transfer at least a portion of the stored electromagnetic energy to the apparatus.

42. The apparatus of claim 39, wherein the wired coupling is to comprise a Universal Serial Bus (USB) coupling.

43. The apparatus of claim 42, wherein the USB coupling includes a type C USB coupling.

44. The apparatus of claim 39, wherein the peripheral device is to comprise one of: a mouse, a trackpad, a keyboard, a smartphone, a touchpad, and a power bank.

45. The apparatus of claim 39, wherein a wireless charging pad is to transmit the electromagnetic energy to the wireless charging receiver coil.

46. The apparatus of claim 45, comprising logic to cause modification to speed of one or more fans, coupled to the wireless charging pad, based at least in part on one or more of: a docking status of the peripheral device, one or more detected temperature values, a battery charge level, and one or more wireless charging pad temperature values to be detected by one or more wireless charging pad sensors that are to be proximate to one or more components of the wireless charging pad.

47. The apparatus of claim 39, wherein the peripheral device is to comprise one or more antennae to receive electromagnetic waves from a wireless charging transmitter.

48. The apparatus of claim 39, wherein the apparatus is to comprise a portable computing device.

49. The apparatus of claim 48, wherein the portable computing device is to comprise one or more of: a System On Chip (SOC) device; a processor, having one or more processor cores; a flat panel display device, memory, a sensor, a wireless communication interface, a Bluetooth interface, and an NFC (Near Field communication) interface.

50. The apparatus of claim 48, wherein the portable computing device is to comprise one of: a smartphone, a 2:1 system, a tablet, a phablet, a UMPC (Ultra-Mobile Personal Computer), a laptop computer, an Ultrabook™ computing device, and a wearable device.
